(19) United States
(12) Patent Application Publication
(10) Pub. No.: US 2026/0018791 A1
(43) Pub. Date: Jan. 15, 2026

(54) ANTENNA DEVICE, ELECTRONIC COMPONENT AND ASSOCIATED METHODS

(71) Applicant: Murata Manufacturing Co., Ltd., Nagaokakyo-shi (JP)

(72) Inventor: Shinya TACHIBANA, Nagaokakyo-shi (JP)

(73) Assignee: Murata Manufacturing Co., Ltd., Nagaokakyo-shi (JP)

(21) Appl. No.: 19/336,567

(22) Filed: Sep. 23, 2025

Related U.S. Application Data
(63) Continuation of application No. PCT/JP2024/002586, filed on Jan. 29, 2024.

(30) Foreign Application Priority Data
May 29, 2023 (JP) 2023-087852

(51) Int. Cl. H01Q 5/307; H01Q 7/00

(52) U.S. Cl. CPC H01Q 5/307; H01Q 7/00

(57) ABSTRACT

An antenna device and an electronic component that establish matching between the impedance of a feed circuit and the impedance of a radiating element in a plurality of frequency ranges are provided. An antenna device includes a feed circuit, a radiating element connected to the feed circuit, and an electronic component between the feed circuit and the radiating element. The electronic component establishes impedance matching between the feed circuit and the radiating element. The electronic component includes a first terminal, a second terminal, a first coil connected in series between the first terminal and the second terminal, a second coil coupled to the coil by magnetic field coupling, and a first capacitor electrically connected in parallel to the coil.

### CROSS-REFERENCE TO RELATED APPLICATIONS

The present application is a bypass continuation of PCT/JP2024/002586, filed Jan. 29, 2024, which claims priority to Japanese patent application 2023-087852, filed May 29, 2023, and the entire contents of each of which being incorporated herein by reference.

### TECHNICAL FIELD

The present disclosure relates to an antenna device and an electronic component.

### BACKGROUND ART

In association with development of communication technologies, antenna devices in recent years have been not only used in a single frequency range but also frequently used in a plurality of frequency ranges. Thus, matching between the impedance of a feed circuit and the impedance of a radiating element is required to be established in the plurality of frequency ranges used. However, in a case in which a single inductor is connected between the feed circuit and the radiating element and matching between the impedance of the feed circuit and the impedance of the radiating element is established, the impedance of the inductor changes depending on the frequency, and thus it has been difficult to establish the matching between the impedance of the feed circuit and the impedance of the radiating element in the plurality of frequency ranges.

As an electronic component for establishing impedance matching of an antenna device, an electronic component including an autotransformer formed of a first coil and a second coil is disclosed in International Publication No. 2020/121874 (Patent Document 1).

### CITATION LIST

### Patent Document

Patent Document 1: International Publication No. 2020/121874

### SUMMARY

### Technical Problems

However, with the electronic component disclosed in International Publication No. 2020/121874, matching of the impedance of the antenna device is established in a wide frequency range by using the autotransformer, and the electronic component is allowed to have an attenuation pole by an LC closed circuit formed of a third coil and a capacitor. That is, this electronic component has a configuration obtained by combining a filter circuit that removes an unnecessary frequency through resonance by the LC closed circuit with the autotransformer that transforms the impedance between the feed circuit and the radiating element. Thus, with this electronic component, it is impossible to establish matching of the impedance of the antenna device in a plurality of frequency ranges around the resonant frequency.

Thus, an object of the present disclosure is to provide an antenna device and an electronic component that establish matching between the impedance of a feed circuit and the impedance of a radiating element in a plurality of frequency ranges.

### Solutions to Problems

An antenna device according to a mode of the present disclosure includes a feed circuit, a radiating element connected to the feed circuit, and an electronic component that is disposed between the feed circuit and the radiating element and establishes impedance matching between the feed circuit and the radiating element. The electronic component includes a first terminal, a second terminal, a first coil connected in series between the first terminal and the second terminal, a second coil coupled to the first coil by magnetic field coupling, and a first capacitor electrically connected in parallel to the second coil.

An electronic component according to a mode of the present disclosure is an electronic component for establishing impedance matching between a feed circuit and a radiating element in an antenna device. The electronic component includes a first terminal, a second terminal, a first coil connected in series between the first terminal and the second terminal, a second coil coupled to the first coil by magnetic field coupling, and a first capacitor electrically connected in parallel to the second coil.

### Advantageous Effects

According to the mode of the present disclosure, matching between the impedance of the feed circuit and the impedance of the radiating element can be established in a plurality of frequency ranges because the electronic component includes the second coil coupled, by the magnetic field coupling, to the first coil connected in series to the first terminal and the second terminal and the first capacitor electrically connected in parallel to the second coil.

### BRIEF DESCRIPTION OF DRAWINGS

FIG. 1 is a circuit diagram of an antenna device according to Embodiment 1.

FIG. 2 is a diagram depicting a Smith chart of the antenna device for explaining impedance matching.

FIG. 3 is a circuit diagram of an antenna device of Comparison Target 1.

FIG. 4 is a graph indicating reactance characteristics of an electronic component according to Embodiment 1.

FIG. 5 is a graph indicating inductance characteristics of the electronic component according to Embodiment 1.

FIG. 6 is a diagram depicting a Smith chart of the antenna device according to Embodiment 1.

FIG. 7 is a diagram indicating the return loss of the antenna device according to Embodiment 1.

FIG. 8 is a circuit diagram of an antenna device of Comparison Target 2.

FIG. 9 is a graph indicating reactance characteristics of an electronic component of Comparison Target 2.

FIG. 10 is a circuit diagram of an antenna device of Comparison Target 3.

FIG. 11 is a diagram depicting a Smith chart of the antenna device according to Comparison Target 3.

FIG. 12 is a diagram indicating the return loss of the antenna device according to Comparison Target 3.

FIG. 13 is a circuit diagram of an antenna device according to Embodiment 2.

FIG. 14 is an exploded plan view depicting a structure of an electronic component according to Embodiment 2.

FIG. 15 is an exploded plan view depicting a structure of an electronic component according to another embodiment.

FIG. 16 is a circuit diagram of an antenna device according to Embodiment 3.

FIG. 17 is a circuit diagram of an antenna device according to Embodiment 4.

FIG. 18 is a graph indicating reactance characteristics of an electronic component according to Embodiment 4.

### DESCRIPTION OF EMBODIMENTS

An antenna device and an electronic component according to the present embodiment are described in detail below with reference to the drawings. In the drawings, the same or corresponding part is given the same numeral, and description thereof is not repeated.

### Embodiment 1

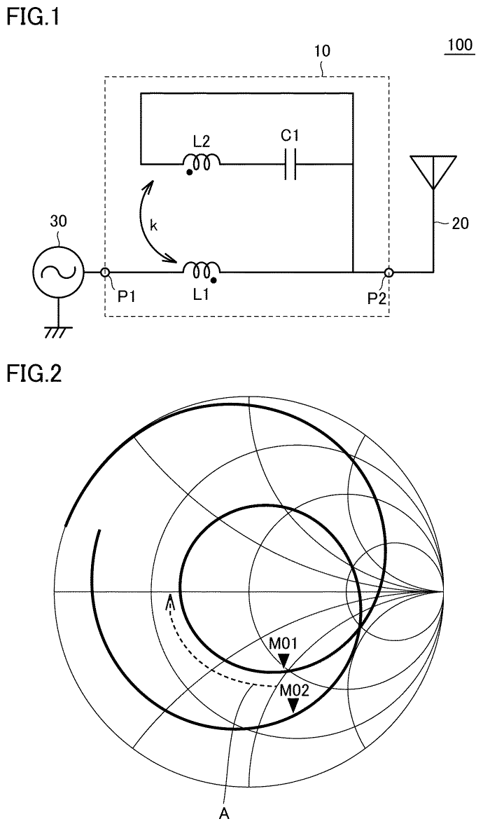

First, an antenna device according to Embodiment 1 is described. FIG. 1 is a circuit diagram of an antenna device 100 according to Embodiment 1. The antenna device 100 includes a radiating element 20, a feed circuit 30 that supplies power to the radiating element 20, and an electronic component 10 for establishing impedance matching between the feed circuit 30 and the radiating element 20. The antenna device 100 is an antenna device capable of communication in a frequency range including, for example, 1 GHz to 5 GHz, and is incorporated in a notebook personal computer, a cellular phone, a smartphone, a tablet, or the like.

### [Impedance Matching]

The antenna device 100 establishes impedance matching between the feed circuit 30 and the radiating element 20 by using the electronic component 10. Prior to description of the impedance matching for the antenna device 100 using the electronic component 10, impedance matching for an antenna device that does not use the electronic component 10 is described. FIG. 2 is a diagram depicting a Smith chart of the antenna device for explaining the impedance matching. In FIG. 2, the Smith chart of the antenna device that does not use the electronic component 10 is depicted.

In the Smith chart depicted in FIG. 2, lines of subject frequencies from 0.1 GHz to 7 GHz are drawn. In a case of desiring to establish impedance matching at frequencies of a mark M01 (approximately 1.0 GHz) and a mark M02 (approximately 4.0 GHz) in the antenna device, the inductance is required to be adjusted such that the mark M01 and the mark M02 are moved in a direction of an arrow A and are positioned in the vicinity of the horizontal line.

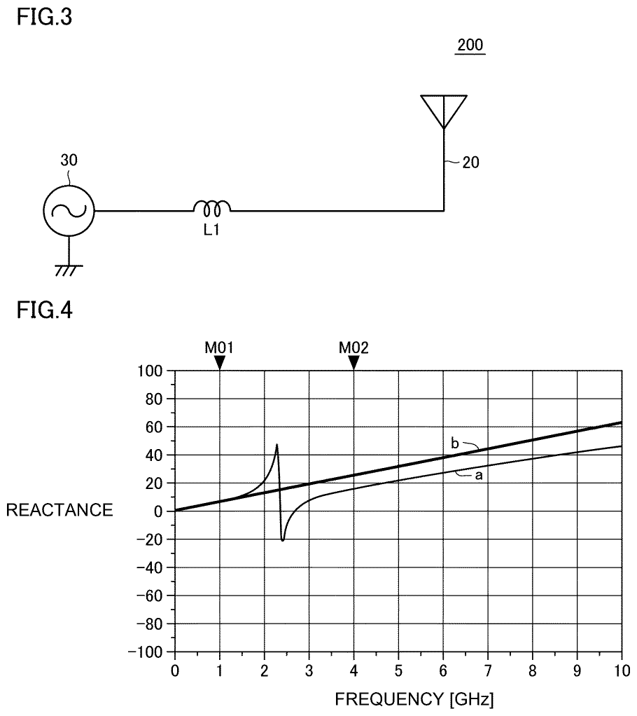

It is conceivable that the inductance is adjusted by using a coil as in, for example, an antenna device of Comparison Target 1 in order to establish matching of the impedance of the antenna device at a specific frequency. FIG. 3 is a circuit diagram of an antenna device 200 of Comparison Target 1. In the antenna device 200, in order to establish impedance matching between the feed circuit 30 and the radiating element 20, a coil L1 that is an inductor is connected in series to the feed circuit 30 and the radiating element 20 to adjust the inductance.

However, when the coil L1 is employed as an electronic component for the impedance matching as in the antenna device 200, the impedance (=jωL) of the coil L1 changes depending on the frequency. The impedance of the coil L1 has a relationship of ω=2πf (f: frequency). Thus, the impedance becomes higher as the frequency f becomes higher. Thus, when the coil L1 is employed as the electronic component for the impedance matching as in the antenna device 200, it is difficult to establish the impedance matching between the feed circuit 30 and the radiating element 20 in a plurality of frequency ranges.

### [Configuration of Electronic Component]

Thus, in the antenna device 100 according to Embodiment 1, the electronic component 10 with a configuration like that depicted in FIG. 1 is employed to establish impedance matching between the feed circuit 30 and the radiating element 20. The electronic component 10 includes a first terminal P1, a second terminal P2, a coil L1 (first coil) connected in series between the first terminal P1 and the second terminal P2, a coil L2 (second coil) coupled to the coil L1 by magnetic field coupling, and a capacitor C1 (first capacitor) electrically connected in parallel to the coil L2. Further, in the electronic component 10, the coil L1 is electrically directly connected (connected by a wiring line) to one end of the coil L2, but is not electrically directly connected (not connected by a wiring line) to the other end of the coil L2. The coil L1 and the coil L2 are differentially connected, and the coupling coefficient between the coil L1 and the coil L2 is defined as k. Even when the connection polarities of the coil L1 and the coil L2 are interchanged to make additional coupling between the coil L1 and the coil L2, there is no change in reactance characteristics and inductance characteristics of the electronic component 10.

The electronic component 10 has a resonant circuit that includes the coil L2 and the capacitor C1 and has a resonant frequency f1 as a parallel circuit for the coil L1, and the coil L1 and the coil L2 are coupled by magnetic field coupling. Thus, the electronic component 10 has characteristics in which inductance Lhi in a frequency range f3 (>f1) higher than the resonant frequency f1 is low compared with inductance Llow in a frequency range f2 (<f1) lower than the resonant frequency f1 (Llow>Lhi).

A description is given of a simulation result of the reactance characteristics and the inductance characteristics concerning the electronic component 10 in a case in which parameters were specifically set as follows: coil L1=1.0 nH, coil L2=2.1 nH, capacitor C1=2.2 pF, and coupling coefficient k=0.5. FIG. 4 is a graph indicating the reactance characteristics of the electronic component 10 according to Embodiment 1. FIG. 5 is a graph indicating the inductance characteristics of the electronic component 10 according to Embodiment 1. The reactance characteristics of the electronic component 10 are calculated by obtaining the imaginary part of a Z11 parameter that is a Z parameter when the first terminal P1 is connected to an input port and the second terminal P2 is connected to a ground (GND). Moreover, the inductance characteristics of the electronic component 10 are calculated by dividing the imaginary part of the obtained Z11 parameter by ω (=2πf).

In FIG. 4, besides a graph a indicating the reactance characteristics of the electronic component 10, a graph b indicating reactance characteristics of a single component of the coil L1 is depicted. The resonant frequency f1 of the electronic component 10 is approximately 2.4 GHz. At the mark M01 (approximately 1.0 GHz) of a frequency lower than the resonant frequency f1, the reactance of the electronic component 10 is substantially the same as that of the single component of the coil L1. However, at the mark M02 (approximately 4.0 GHz) of a frequency higher than the resonant frequency f1, the reactance of the electronic component 10 is lower than that of the single component of the coil L1. The reactance of the electronic component 10 and the reactance of the single component of the coil L1 are the same in a tendency that the reactance becomes higher as the frequency becomes higher.

In FIG. 5, besides a graph c indicating the inductance characteristics of the electronic component 10, a graph d indicating inductance characteristics of the single component of the coil L1 is depicted. At the mark M01 (approximately 1.0 GHz) of the frequency lower than the resonant frequency f1, the inductance of the electronic component 10 is higher than that of the single component of the coil L1. However, at the mark M02 (approximately 4.0 GHz) of the frequency higher than the resonant frequency f1, the inductance of the electronic component 10 is lower than that of the single component of the coil L1. The graph d indicating the inductance characteristics of the single component of the coil L1 exhibits a constant value irrespective of the frequency.

That is, the inductance characteristics of the electronic component 10 have characteristics in which the inductance becomes lower than that of the single component of the coil L1 in the frequency range higher than the resonant frequency f1. Thus, the antenna device 100 can establish impedance matching between the feed circuit 30 and the radiating element 20 in a plurality of frequency ranges by using the inductance characteristics of this electronic component 10. In the present disclosure, the description has been given of the example in which the electronic component 10 is used for the antenna device 100 as an element that establishes impedance matching. However, the electronic component 10 may be used as an element that establishes impedance matching in a high frequency circuit such as a radio frequency (RF) circuit other than the antenna device by using the inductance characteristics of this electronic component 10. For example, the electronic component 10 may be used for impedance matching or filtering in radio frequency (RF) circuits, e.g., amplifiers, mixers, or other circuits requiring different reactive properties at different operating frequencies.

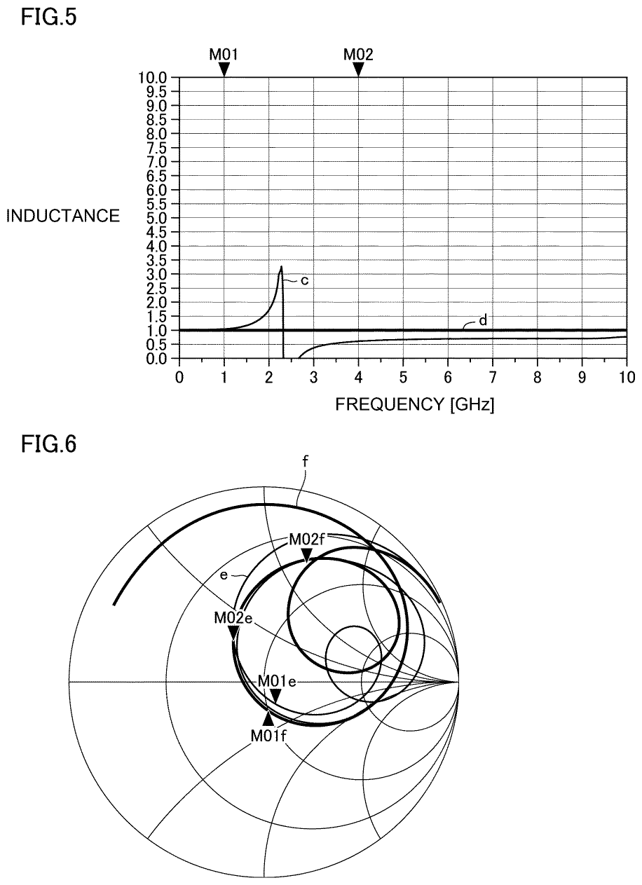

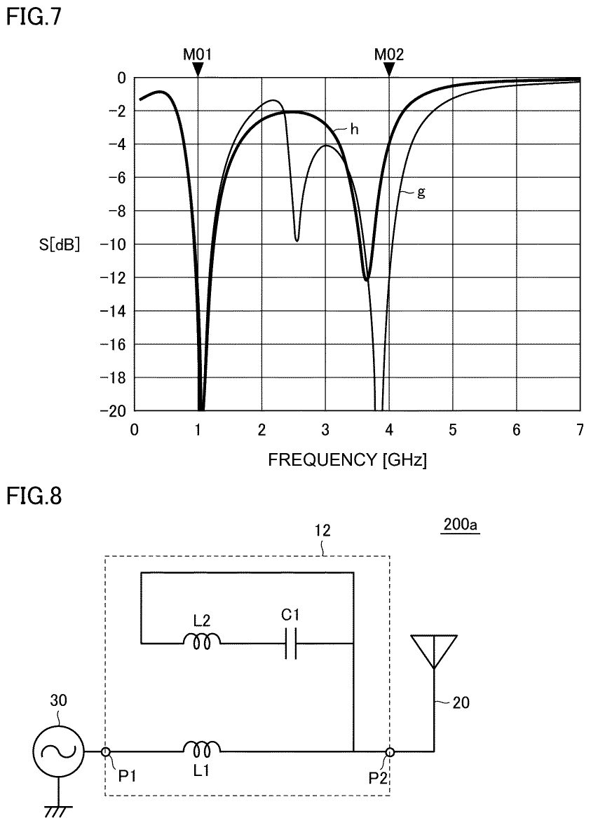

Next, a description is given of characteristics of the antenna device 100 in which impedance matching between the feed circuit 30 and the radiating element 20 is established by using the electronic component 10. A description is given of a simulation result of the characteristics of the antenna device 100 using the electronic component 10 in a case in which parameters were specifically set as follows: coil L1=5.0 nH, coil L2=2.1 nH, capacitor C1=2.2 pF, and coupling coefficient k=0.5. FIG. 6 is a diagram depicting a Smith chart of the antenna device 100 according to Embodiment 1. FIG. 7 is a diagram indicating the return loss of the antenna device 100 according to Embodiment 1.

In the Smith chart depicted in FIG. 6, lines of subject frequencies from 0.1 GHz to 7 GHz are drawn. In FIG. 6, besides a line e of the antenna device 100 using the electronic component 10, a line f of the antenna device 200 using the single component of the coil L1 is depicted. On the line e of the antenna device 100, when impedance matching is established at the frequency of a mark M01e (approximately 1.0 GHz), a mark M02e (approximately 4.0 GHz) of the antenna device 100 becomes closer to the horizontal line than a mark M02f (approximately 4.0 GHz) of the antenna device 200, and the value of the imaginary part of this mark comes closer to 0Ω. Thus, matching can be established. Specifically, the impedance of the mark M02e is approximately 33.8+j14.7Ω, whereas the impedance of the mark M02f is approximately 31.5+j62.3Ω. Thus, at the mark M02e, the imaginary part is smaller and matching can be established at a higher degree.

Further, also in the return loss of the antenna devices depicted in FIG. 7, return loss g of the antenna device 100 decreases compared with return loss h of the antenna device 200 at the mark M02 (approximately 4.0 GHz). Thus, it turns out that impedance matching is established at a higher degree in the antenna device 100 than in the antenna device 200 in a frequency range around approximately 4.0 GHz. In FIG. 7, a horizontal axis indicates the frequency, and a vertical axis indicates the return loss. The return loss is a reflection coefficient of the antenna devices 100 and 200 when the electronic component 10 or the single component of the coil L1 is seen from the feed circuit 30 in FIG. 1 or 3.

As described above, in the antenna device 200, inductance matching is executed by using the single component of the coil L1. Thus, the impedance of the coil L1 changes on the basis of the formula of the reactance (=jωL). Therefore, when adjustment to the impedance at a low frequency is executed, the impedance of the coil L1 becomes higher beyond necessity at a high frequency. On the other hand, in the antenna device 100, inductance matching is executed by using the electronic component 10. Thus, even when adjustment to the impedance at a low frequency is executed, low impedance can be implemented even at a high frequency. Accordingly, impedance matching between the feed circuit 30 and the radiating element 20 can be established both at the low frequency and at the high frequency.

Due to the magnetic field coupling between the coil L1 and the coil L2, the electronic component 10 has the characteristics in which the inductance Lhi in the frequency range f3 higher than the resonant frequency f1 is low compared with the inductance Llow in the frequency range f2 lower than the resonant frequency f1 (Llow>Lhi). A description is given of the fact that the magnetic field coupling between the coil L1 and the coil L2 is a required configuration in the electronic component 10, with use of an antenna device of Comparison Target 2. FIG. 8 is a circuit diagram of an antenna device 200a of Comparison Target 2. The antenna device 200a establishes impedance matching between the feed circuit 30 and the radiating element 20 by using an electronic component 12. The electronic component 12 includes the first terminal P1, the second terminal P2, the coil L1 connected in series between the first terminal P1 and the second terminal P2, the coil L2 that is not coupled to the coil L1 by magnetic field coupling, and the capacitor C1 electrically connected in parallel to the coil L2. Moreover, in the electronic component 12, the coil L1 is electrically directly connected to one end of the coil L2, but is not electrically directly connected to the other end of the coil L2.

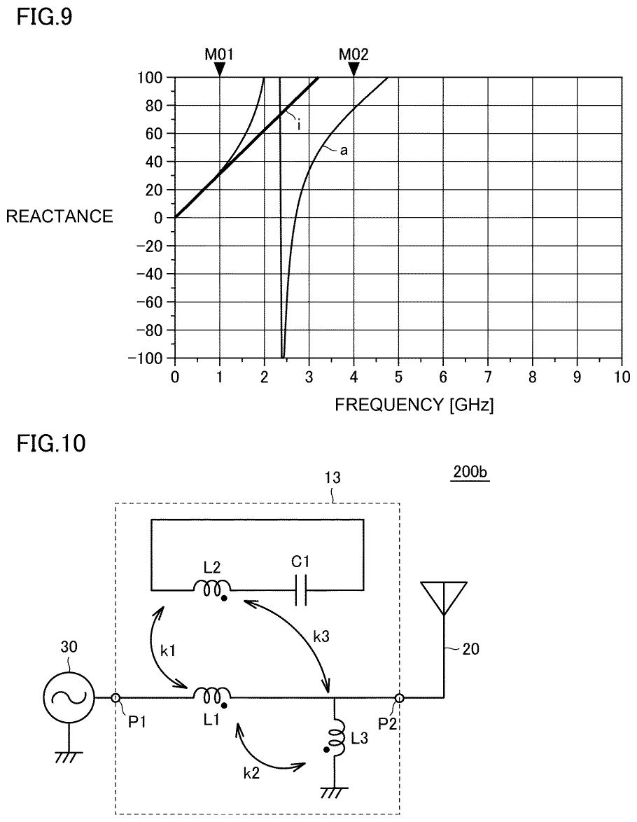

The electronic component 12 has a resonant circuit that includes the coil L2 and the capacitor C1 and has the resonant frequency f1 as a parallel circuit for the coil L1, but magnetic field coupling between the coil L1 and the coil L2 is not made. Thus, reactance characteristics and inductance characteristics of the electronic component 12 are substantially the same as the reactance characteristics and the inductance characteristics of the single component of the coil L1. A description is given of a simulation result of the reactance characteristics concerning the electronic component 12 in a case in which parameters were specifically set as follows: coil L1=5.0 nH, coil L2=2.1 nH, capacitor C1=2.2 pF, and coupling coefficient k=0. FIG. 9 is a graph indicating the reactance characteristics of the electronic component 12 of Comparison Target 2.

In FIG. 9, besides a graph i indicating the reactance characteristics of the electronic component 12, the graph a indicating the reactance characteristics of the electronic component 10 is depicted. In the graph i indicating the reactance characteristics of the electronic component 12, the reactance does not change across the resonant frequency f1 differently from the graph a indicating the reactance characteristics of the electronic component 10, and monotonically becomes higher as the frequency becomes higher as with the reactance characteristics of the single component of the coil L1. Thus, the inductance characteristics of the electronic component 12 exhibit a constant value irrespective of the frequency as with the inductance characteristics of the single component of the coil L1 substantially. For the electronic component 12, in which magnetic field coupling between the coil L1 and the coil L2 is not made, it is difficult to establish impedance matching between the feed circuit 30 and the radiating element 20 in a plurality of frequency ranges, as with the single component of the coil L1. That is, it turns out that the magnetic field coupling between the coil L1 and the coil L2 is a required configuration in the electronic component 10.

Next, a description is given of an antenna device of Comparison Target 3 using an electronic component that has a shunt-connected coil and in which the coil L2 is coupled also to this coil by magnetic field coupling. FIG. 10 is a circuit diagram of an antenna device 200b of Comparison Target 3. The antenna device 200b establishes impedance matching between the feed circuit 30 and the radiating element 20 by using an electronic component 13. The electronic component 13 includes the first terminal P1, the second terminal P2, the coil L1 connected in series between the first terminal P1 and the second terminal P2, a coil L3 shunt-connected to a wiring line that couples the first terminal P1 to the second terminal P2, the coil L2 coupled to the coil L1 and the coil L3 by magnetic field coupling, and the capacitor C1 electrically connected in parallel to the coil L2. Moreover, the coil L1 and the coil L3 of the electronic component 13 are not electrically directly connected to the coil L2.

The electronic component 13 has a resonant circuit that includes the coil L2 and the capacitor C1 and has the resonant frequency f1 as a parallel circuit for the coil L1, and the coil L1 and the coil L2 are coupled by magnetic field coupling. However, in the electronic component 13, the coil L3 is shunt-connected for the radiating element 20. This changes the impedance of the antenna device 200b. Specifically, due to the shunt connection of the coil L3, movement in an anticlockwise manner is made on a locus of an admittance chart. Thus, if movement is made to an upper half region of a Smith chart, the point is distant from the center of the Smith chart (50Ω) also due to the inductance component of the coil L1, the coil L2, and the capacitor C1, and impedance matching becomes difficult. Thus, it is difficult for the antenna device 200b using the electronic component 13 to establish impedance matching between the feed circuit 30 and the radiating element 20 in a plurality of frequency ranges required.

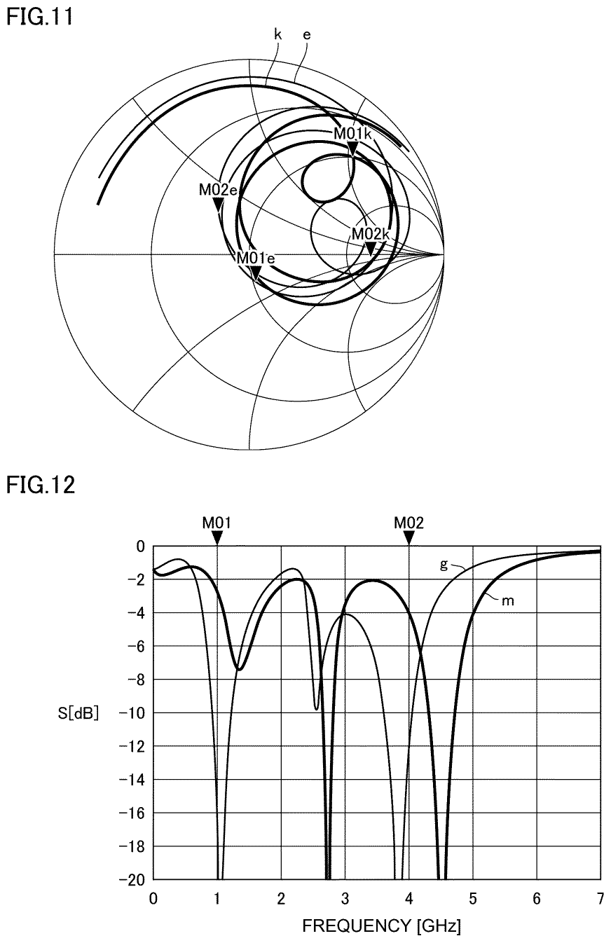

A description is given of a simulation result of characteristics of the antenna device 200b using the electronic component 13 in a case in which parameters were specifically set as follows: coil L1=5.0 nH, coil L2=2.1 nH, coil L3=5.0 nH, capacitor C1=2.2 pF, coupling coefficient k1 between coil L1 and coil L2=0.5, coupling coefficient k2 between coil L1 and coil L3=0.5, and coupling coefficient k3 between coil L2 and coil L3=0.4. FIG. 11 is a diagram depicting a Smith chart of the antenna device 200b according to Comparison Target 3. FIG. 12 is a diagram indicating the return loss of the antenna device 200b according to Comparison Target 3.

In the Smith chart depicted in FIG. 11, lines of subject frequencies from 0.1 GHz to 7 GHz are drawn. In FIG. 11, besides a line k of the antenna device 200b using the electronic component 13, the line e of the antenna device 100 using the electronic component 10 is depicted. On the line k of the antenna device 200b, the point is far distant from the horizontal line at a position of a mark M01k (approximately 1.0 GHz), and the value of the real part of a mark M02k (approximately 4.0 GHz) is larger than 50Ω. Specifically, the impedance of the mark M02e is approximately 33.78+j14.7Ω, and the impedance of the mark M02k is approximately 214.32−j21.5Ω. Thus, the value of the real part of the mark M02e is approximately 33.78Ω, whereas the value of the real part of the mark M02k is as large as approximately 214.32Ω. Therefore, matching is not established.

Further, also in the return loss of the antenna devices depicted in FIG. 12, the impedance of the antenna device 200b greatly deviates, and return loss m of the antenna device 200b increases compared with the return loss g of the antenna device 100 at the mark M02 (approximately 4.0 GHz). Thus, it turns out that impedance matching is not established in a frequency range around approximately 4.0 GHz in the antenna device 200b differently from the antenna device 100. In FIG. 12, a horizontal axis indicates the frequency, and a vertical axis indicates the return loss. On the other hand, the antenna device 100 can suppress the return loss to low return loss at the mark M01 (approximately 1.0 GHz) and the mark M02 (approximately 4.0 GHz). Therefore, it turns out that the antenna device 100 establishes impedance matching between the feed circuit 30 and the radiating element 20 both at the low frequency and at the high frequency.

### Embodiment 2

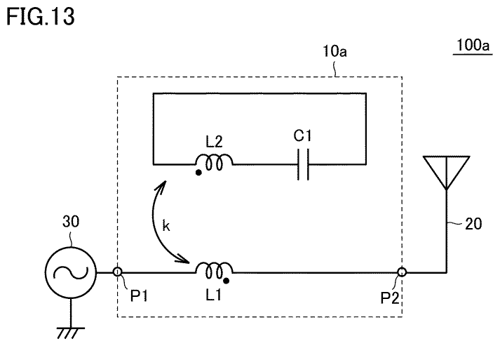

The electronic component 10 according to Embodiment 1 has the configuration in which the coil L1 is electrically directly connected to one end of the coil L2 but is not electrically directly connected to the other end of the coil L2. However, the coil L1 is not required to be electrically connected to the one end of the coil L2. Thus, with an electronic component according to Embodiment 2, a configuration in which the coil L1 is not electrically directly connected to the coil L2 is described. FIG. 13 is a circuit diagram of an antenna device 100a according to Embodiment 2. The antenna device 100a includes the radiating element 20, the feed circuit 30 that supplies power to the radiating element 20, and an electronic component 10a for establishing impedance matching between the feed circuit 30 and the radiating element 20.

The electronic component 10a includes the first terminal P1, the second terminal P2, the coil L1 (first coil) connected in series between the first terminal P1 and the second terminal P2, the coil L2 (second coil) coupled to the coil L1 by magnetic field coupling, and the capacitor C1 electrically connected in parallel to the coil L2. Moreover, in the electronic component 10a, the coil L1 is not electrically directly connected (not connected by a wiring line) to the coil L2. The coil L1 and the coil L2 are differentially connected, and the coupling coefficient between the coil L1 and the coil L2 is defined as k. Even when the connection polarities of the coil L1 and the coil L2 are interchanged to make additional coupling between the coil L1 and the coil L2, there is no change in reactance characteristics and inductance characteristics of the electronic component 10a.

Thus, the reactance characteristics and the inductance characteristics of the electronic component 10a are substantially the same as the reactance characteristics and the inductance characteristics of the electronic component 10. That is, the electronic component 10a has the characteristics in which the inductance Lhi in the frequency range f3 (>f1) higher than the resonant frequency f1 is low compared with the inductance Llow in the frequency range f2 (<f1) lower than the resonant frequency f1 (Llow>Lhi). Thus, in the inductance characteristics of the electronic component 10a, the inductance becomes lower than that of the single component of the coil L1 in the frequency range higher than the resonant frequency f1. Therefore, the antenna device 100a can establish impedance matching between the feed circuit 30 and the radiating element 20 in a plurality of frequency ranges by using the inductance characteristics of this electronic component 10a.

The electronic component 10a can establish impedance matching between the feed circuit 30 and the radiating element 20 in a plurality of frequency ranges as with the electronic component 10, and the inductance characteristics and the like are almost the same therebetween. However, the structures are different. The electronic component 10a can be formed as a chip component that includes the coil L1, the coil L2, and the capacitor C1 and has a rectangular parallelepiped shape. Specifically, the electronic component may be housed within a single body formed from a plurality of laminated insulating layers. The first coil, the second coil, and the first capacitor may be integrally formed within this single body during the manufacturing and lamination process, forming a monolithic structure.

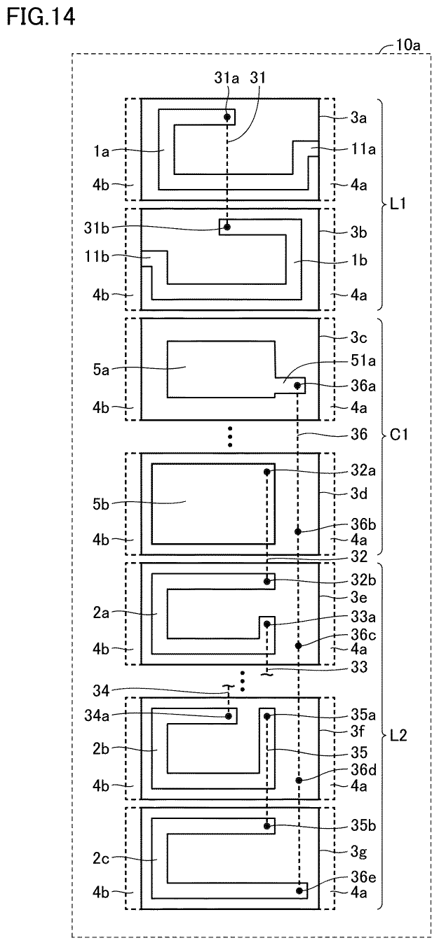

A specific structure of the electronic component 10a is described. FIG. 14 is an exploded plan view depicting a structure of the electronic component 10a according to Embodiment 2. The electronic component 10a is formed of an insulator (ceramic element) obtained by laminating a plurality of substrates (ceramic green sheets) on which a wiring line of a coil or a capacitor depicted in FIG. 14 is formed. The insulator has a pair of major surfaces opposite to each other and side surfaces that couple the major surfaces. A plurality of conductor patterns 1a, 1b, and 2a to 2c and a plurality of electrode patterns 5a and 5b are laminated in parallel to the major surfaces of an insulator 1, to form the electronic component 10a including the coil L1, the coil L2, and the capacitor C1.

As depicted in FIG. 14, each of the conductor patterns 1a, 1b, and 2a to 2c, wiring patterns 11a, 11b, and 51, and the electrode patterns 5a and 5b is formed on an insulating substrate 3a to 3g by a printing method. The electronic component 10a is formed by laminating the insulating substrates 3a to 3g on which these conductor patterns 1a, 1b, and 2a to 2c and the like are formed. In particular, as discussed in detail below, the conductor patterns 1a, 1b, and 2a to 2c are formed in substantially spiral or meander shapes on their respective insulating substrates (3a-3g). When the insulating substrates are laminated, these conductor patterns are vertically stacked and interconnected by via conductors to form the multi-turn first coil L1 and second coil L2. The vertical alignment and proximity of the first coil L1 and the second coil L2 within the laminated structure facilitates the magnetic field coupling between them.

The conductor pattern 1a forming part of the coil L1 is formed on the insulating substrate 3a. The conductor pattern 1a is formed to make an approximately ¾ turn in a clockwise manner from the right side of the insulating substrate 3a in the diagram. The starting end of the conductor pattern 1a is electrically connected to an external electrode 4a through the wiring pattern 11a. The external electrode 4a corresponds to, for example, the first terminal P1 depicted in FIG. 1. A connection portion 31a connected to a via conductor 31 is disposed near the terminating end of the conductor pattern 1a.

The conductor pattern 1b forming part of the coil L1 is formed on the insulating substrate 3b. The conductor pattern 1b is formed to make an approximately ¾ turn in a clockwise manner from the middle of the insulating substrate 3b in the diagram. A connection portion 31b connected to the via conductor 31 is disposed near the starting end of the conductor pattern 1b. The terminating end of the conductor pattern 1b is electrically connected to an external electrode 4b through the wiring pattern 11b. The external electrode 4b corresponds to, for example, the second terminal P2 depicted in FIG. 1. As the coil L1, a coil of approximately 1.5 turns is formed by connecting the conductor patterns 1a and 1b by the via conductor 31.

The electrode pattern 5a forming one electrode (first electrode) of the capacitor C1 is formed on the insulating substrate 3c. The electrode pattern 5a is disposed in a region partly overlapping with opening portions of the coils L1 and L2 as viewed in plan view from the layer lamination direction. Of course, the electrode pattern 5a may be disposed at a position that does not overlap with the opening portions of the coils L1 and L2, and the electronic component 10a may be implemented without interference with a magnetic field made by the coils L1 and L2. The electrode pattern 5a has a connection portion 36a connected to a via conductor 36.

The electrode pattern 5b forming one electrode (second electrode) of the capacitor C1 is formed on the insulating substrate 3d. The electrode pattern 5b is disposed at a position overlapping with the electrode pattern 5a formed on the insulating substrate 3c as viewed in plan view from the layer lamination direction. The area of the electrode pattern 5b is larger than that of the electrode pattern 5a. Of course, the area of the electrode pattern 5a may be larger than that of the electrode pattern 5b. A connection portion 32a connected to a via conductor 32 is disposed near one end of the electrode pattern 5b. Further, in the insulating substrate 3d, a connection portion 36b connected to the via conductor 36 is disposed at a position at which the electrode pattern 5b is not disposed. The capacitor C1 is formed with the electrode pattern 5a and the electrode pattern 5b, and a plurality of insulating substrates are laminated between the insulating substrate 3c and the insulating substrate 3d. An electrode that overlaps with the electrode patterns 5a and 5b as viewed in plan view from the layer lamination direction may be disposed as a floating electrode on the insulating substrate laminated between the insulating substrate 3c and the insulating substrate 3d.

The conductor pattern 2a forming part of the coil L2 is formed on the insulating substrate 3e. The conductor pattern 2a is formed to make an approximately one turn in an anticlockwise manner from the upper right side of the insulating substrate 3e in the diagram. A connection portion 32b connected to the via conductor 32 is disposed near the starting end of the conductor pattern 2a. A connection portion 33a connected to a via conductor 33 is disposed near the terminating end of the conductor pattern 2a. Moreover, in the insulating substrate 3e, a connection portion 36c connected to the via conductor 36 is disposed at a position at which the conductor pattern 2a is not disposed.

The conductor pattern 2b forming part of the coil L2 is formed on the insulating substrate 3f. The conductor pattern 2b is formed to make an approximately one turn in an anticlockwise manner from the upper right side of the insulating substrate 3f in the diagram. A connection portion 34a connected to a via conductor 34 is disposed near the starting end of the conductor pattern 2b. A connection portion 35a connected to a via conductor 35 is disposed near the terminating end of the conductor pattern 2b. Further, in the insulating substrate 3f, a connection portion 36d connected to the via conductor 36 is disposed at a position at which the conductor pattern 2b is not disposed. A plurality of insulating substrates on which a conductor pattern forming part of the coil L2 is formed are disposed between the insulating substrate 3e and the insulating substrate 3f, but depiction thereof is omitted.

The conductor pattern 2c forming part of the coil L2 is formed on the insulating substrate 3g. The conductor pattern 2c is formed to make an approximately ¾ turn in an anticlockwise manner from the upper right side of the insulating substrate 3g in the diagram. A connection portion 35b connected to the via conductor 35 is disposed near the starting end of the conductor pattern 2c. A connection portion 36e connected to the via conductor 36 is disposed near the terminating end of the conductor pattern 2c. As the coil L2, a coil of a plurality of turns is formed by connecting the conductor patterns 2a to 2c by the via conductors 33 to 35.

The electronic component 10a is formed as depicted in FIG. 14. Thus, neither of the ends of the coil L2 is required to be connected to the external electrode 4a or 4b. This avoids the constraint that at least one of the conductor patterns 2a to 2c is connected to the external electrode 4a or 4b. Thus, the flexibility of design increases.

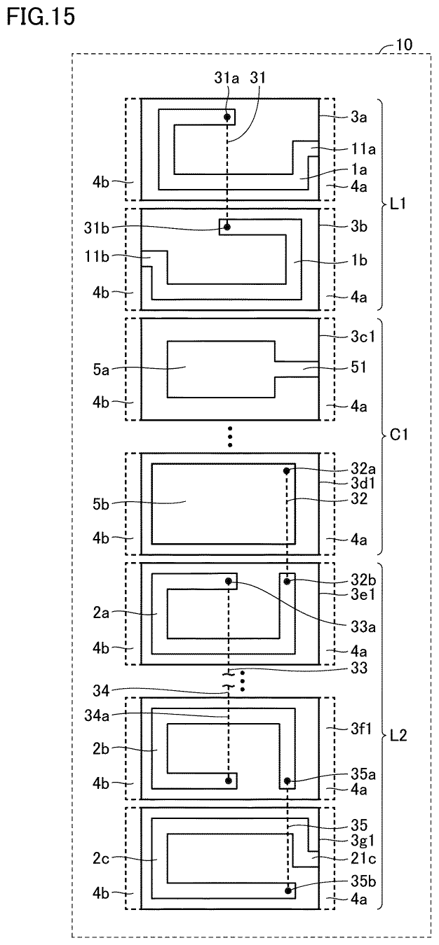

Meanwhile, in the electronic component 10 according to another embodiment, the coil L1 is electrically connected to one end of the coil L2. Thus, at least one of a plurality of conductor patterns forming the coil L2 is required to be connected to an external electrode. FIG. 15 is an exploded plan view depicting a structure of the electronic component 10 according to the other embodiment. In the exploded plan view depicting the structure of the electronic component 10, the same constituent element as the exploded plan view depicting the structure of the electronic component 10a depicted in FIG. 14 is given the same numeral, and detailed description thereof is not repeated.

The electrode pattern 5a forming one electrode (first electrode) of the capacitor C1 is formed on an insulating substrate 3c1. The electrode pattern 5a is disposed in a region partly overlapping with the opening portions of the coils L1 and L2 as viewed in plan view from the layer lamination direction. Of course, the electrode pattern 5a may be disposed at a position that does not overlap with the opening portions of the coils L1 and L2, and the electronic component 10 may be implemented without interference with a magnetic field made by the coils L1 and L2. One end of the electrode pattern 5a is electrically connected to the external electrode 4a through the wiring pattern 51.

The electrode pattern 5b forming one electrode (second electrode) of the capacitor C1 is formed on an insulating substrate 3d1. The electrode pattern 5b is disposed at a position overlapping with the electrode pattern 5a formed on the insulating substrate 3c as viewed in plan view from the layer lamination direction. The area of the electrode pattern 5b is larger than that of the electrode pattern 5a. Of course, the area of the electrode pattern 5a may be larger than that of the electrode pattern 5b. The connection portion 32a connected to the via conductor 32 is disposed near one end of the electrode pattern 5b. The capacitor C1 is formed with the electrode pattern 5a and the electrode pattern 5b, and a plurality of insulating substrates are laminated between the insulating substrate 3c and the insulating substrate 3d1. An electrode that overlaps with the electrode patterns 5a and 5b as viewed in plan view from the layer lamination direction may be disposed as a floating electrode on the insulating substrate laminated between the insulating substrate 3c and the insulating substrate 3d1.

The conductor pattern 2a forming part of the coil L2 is formed on an insulating substrate 3e1. The conductor pattern 2a is formed to make an approximately one turn in a clockwise manner from the upper right side of the insulating substrate 3e1 in the diagram. The connection portion 32b connected to the via conductor 32 is disposed near the starting end of the conductor pattern 2a. The connection portion 33a connected to the via conductor 33 is disposed near the terminating end of the conductor pattern 2a.

The conductor pattern 2b forming part of the coil L2 is formed on an insulating substrate 3f1. The conductor pattern 2b is formed to make an approximately one turn on the insulating substrate 3f1. The connection portion 34a connected to the via conductor 34 is disposed near the starting end of the conductor pattern 2b. The connection portion 35a connected to the via conductor 35 is disposed near the terminating end of the conductor pattern 2b. A plurality of insulating substrates on which a conductor pattern forming part of the coil L2 is formed are disposed between the insulating substrate 3e1 and the insulating substrate 3f1, but depiction thereof is omitted.

The conductor pattern 2c forming part of the coil L2 is formed on an insulating substrate 3g1. The conductor pattern 2c is formed to make an approximately ¾ turn on the insulating substrate 3g1. The connection portion 35b connected to the via conductor 35 is disposed near the starting end of the conductor pattern 2c. The terminating end of the conductor pattern 2c is electrically connected to the external electrode 4a through a wiring pattern 21c.

The electronic component 10 is formed as depicted in FIG. 15. Thus, one end of the coil L2 connects to the external electrode 4a. For this connection, the wiring pattern 21c is formed as a lead-out wiring line for connecting the conductor pattern 2c of the coil L2 to the external electrode 4a. Thus, this wiring pattern 21c can also be used as the inductance of the coil L2, and the size of the electronic component 10 can be reduced.

### Embodiment 3

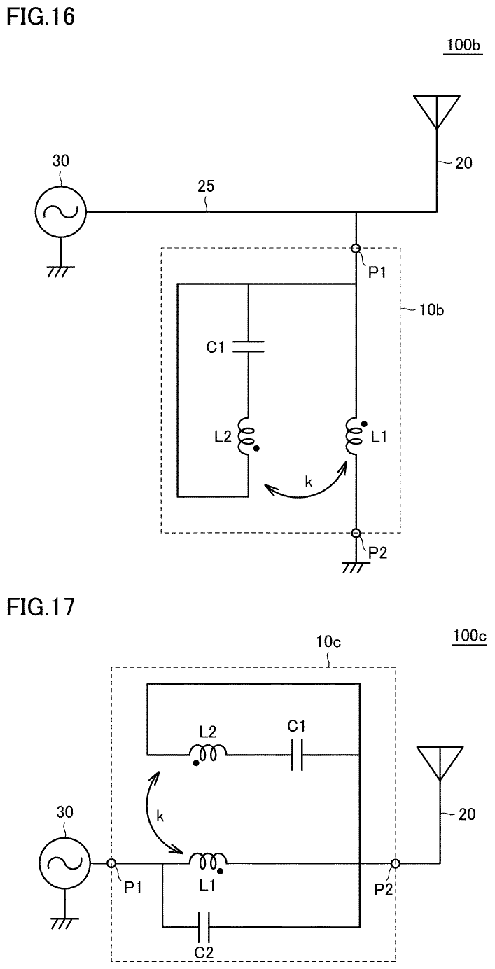

Concerning the antenna device 100 according to Embodiment 1, the description has been given of the configuration in which the electronic component 10 is connected in series between the feed circuit 30 and the radiating element 20 as depicted in FIG. 1. However, the connection method for the electronic component 10 is not limited to the series connection. With an antenna device according to Embodiment 3, a configuration in which an electronic component is shunt-connected is described. FIG. 16 is a circuit diagram of an antenna device 100b according to Embodiment 3.

The antenna device 100b includes the radiating element 20, the feed circuit 30 that supplies power to the radiating element 20, and an electronic component 10b for establishing impedance matching between the feed circuit 30 and the radiating element 20. The electronic component 10b includes the first terminal P1 electrically connected to a wiring line 25 that couples the radiating element 20 to the feed circuit 30, the second terminal P2 electrically connected to the ground (GND), the coil L1 (first coil) connected in series between the first terminal P1 and the second terminal P2, the coil L2 (second coil) coupled to the coil L1 by magnetic field coupling, and the capacitor C1 electrically connected in parallel to the coil L2. Further, in the electronic component 10b, the coil L1 is electrically directly connected to one end of the coil L2, but is not electrically directly connected to the other end of the coil L2. Of course, the coil L1 is not required to be electrically connected to the coil L2 in the electronic component 10b.

In the antenna device 100b, the electronic component 10b is shunt-connected to the wiring line 25 that couples the radiating element 20 to the feed circuit 30. This allows the antenna device 100b to establish impedance matching between the feed circuit 30 and the radiating element 20. Moreover, the antenna device 100b can be regarded as an inverted-F antenna (IFA) because the wiring line 25 is connected to the ground (GND) through the electronic component 10b, and the electronic component 10b functions also as a short-circuit point.

### Embodiment 4

In the antenna device 100 according to Embodiment 1, the electronic component 10 including the capacitor C1 (first capacitor) electrically connected in parallel to the coil L2 as depicted in FIG. 1 is employed. However, the capacitor included in the electronic component 10 is not limited to the capacitor C1. In an antenna device according to Embodiment 4, an electronic component including a capacitor electrically connected in parallel to the coil L2 is employed. FIG. 17 is a circuit diagram of an antenna device 100c according to Embodiment 4.

The antenna device 100c establishes impedance matching between the feed circuit 30 and the radiating element 20 by using an electronic component 10c. The electronic component 10c includes the first terminal P1, the second terminal P2, the coil L1 (first coil) connected in series between the first terminal P1 and the second terminal P2, a capacitor C2 (second capacitor) electrically connected in parallel to the coil L1, the coil L2 (second coil) coupled to the coil L1 by magnetic field coupling, and the capacitor C1 electrically connected in parallel to the coil L2. Further, in the electronic component 10c, the coil L1 is electrically directly connected (connected by a wiring line) to one end of the coil L2, but is not electrically directly connected (not connected by a wiring line) to the other end of the coil L2. The coil L1 and the coil L2 are differentially connected, and the coupling coefficient between the coil L1 and the coil L2 is defined as k. Even when the connection polarities of the coil L1 and the coil L2 are interchanged to make additional coupling between the coil L1 and the coil L2, there is no change in reactance characteristics and inductance characteristics of the electronic component 10c.

The electronic component 10c has a resonant circuit that includes the coil L2 and the capacitor C1 and has the resonant frequency f1 as a parallel circuit for the coil L1. In addition, the capacitor C2 is connected in parallel to the coil L1. Thus, in the electronic component 10c, the reactance characteristics can be made negative (capacitive) on the side of the frequency range f3 (>f1) higher than the resonant frequency f1 (particularly, 3 GHz or higher), and there is no need to add another capacitor in order to newly obtain matching on the side of the high frequency range f3.

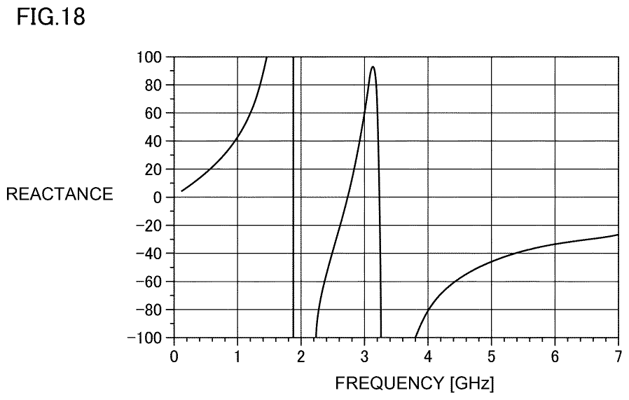

A description is given of a result of a simulation of the reactance characteristics executed concerning the electronic component 10c in a case in which parameters were specifically set as follows: coil L1=5.0 nH, coil L2=2.1 nH, capacitor C1=2.2 pF, capacitor C2=1.0 pF, and coupling coefficient k=0.5. FIG. 18 is a graph indicating the reactance characteristics of the electronic component 10c according to Embodiment 4. In FIG. 18, the graph indicating the reactance characteristics of the electronic component 10c is depicted. From FIG. 18, it turns out that the reactance characteristics become negative (capacitive) in a frequency region higher than 3 GHz.

The configuration in which the capacitor C2 is connected in parallel to the coil L1 may be applied to the antenna device 100a depicted in FIG. 13 and the antenna device 100b depicted in FIG. 16.

### Aspects

(1) An antenna device according to the present disclosure, comprising:
a feed circuit;
a radiating element connected to the feed circuit; and
an electronic component that is disposed between the feed circuit and the radiating element and establishes impedance matching between the feed circuit and the radiating element, wherein
the electronic component includes
   a first terminal,
   a second terminal,
   a first coil connected in series between the first terminal and the second terminal,
   a second coil coupled to the first coil by magnetic field coupling, and
   a first capacitor electrically connected in parallel to the second coil.

Due to this, the antenna device according to the present disclosure can establish matching between the impedance of the feed circuit and the impedance of the radiating element in a plurality of frequency ranges because the electronic component includes the second coil coupled, by the magnetic field coupling, to the first coil connected in series to the first terminal and the second terminal and the first capacitor electrically connected in parallel to the second coil.

(2) The antenna device according to (1), wherein
a resonant frequency of a parallel circuit including the second coil and the first capacitor is a frequency between a plurality of resonant frequencies of the radiating element.

(3) The antenna device according to (1) or (2), wherein
the first coil is electrically directly connected to one end of the second coil, and is not electrically directly connected to the other end of the second coil.

(4) The antenna device according to (1) or (2), wherein
the first coil is not electrically directly connected to the second coil.

(5) The antenna device according to any one of (1) to (4), wherein
in the electronic component, the first terminal is electrically connected to the feed circuit and the second terminal is electrically connected to the radiating element.

(6) The antenna device according to any one of (1) to (4), wherein
in the electronic component, the first terminal is electrically connected between the feed circuit and the radiating element and the second terminal is electrically connected to a ground electrode.

(7) The antenna device according to any one of (1) to (6), wherein
the electronic component further includes a second capacitor electrically connected in parallel to the first coil.

(8) An electronic component according to the present disclosure, the electronic component being an electronic component for establishing impedance matching between a feed circuit and a radiating element in an antenna device, the electronic component comprising:
a first terminal;
a second terminal;
a first coil connected in series between the first terminal and the second terminal;
a second coil coupled to the first coil by magnetic field coupling; and
a first capacitor electrically connected in parallel to the second coil.

Due to this, the electronic component according to the present disclosure can establish matching between the impedance of the feed circuit and the impedance of the radiating element in the antenna device in a plurality of frequency ranges because including the second coil coupled, by the magnetic field coupling, to the first coil connected in series to the first terminal and the second terminal and the first capacitor electrically connected in parallel to the second coil.

(9) The electronic component according to (8), wherein
the first coil is electrically directly connected to one end of the second coil, and is not electrically directly connected to the other end of the second coil.

(10) The electronic component according to (8), wherein
the first coil is not electrically directly connected to the second coil.

(11) The electronic component according to any one of (8) to (10), further comprising:
a second capacitor electrically connected in parallel to the first coil.

It should be thought that the embodiment disclosed this time is an example in terms of all points and is not restrictive. It is intended that the scope of the present invention is indicated by not the above description but the scope of claims and meanings equivalent to the scope of claims and all changes in the scope are included in the scope of the present invention.

### REFERENCE SIGNS LIST

1a, 1b, 2a to 2c conductor pattern
3a to 3g insulating substrate
4a, 4b external electrode
5a, 5b electrode pattern
10, 10a, 10b electronic component
11a, 11b, 21c, 51 wiring pattern
20 radiating element
30 feed circuit
31 to 36 via conductor
100, 100a, 100b antenna device

1. An antenna device comprising:
a feed circuit;
a radiating element connected to the feed circuit; and
an electronic component between the feed circuit and the radiating element and establishes impedance matching between the feed circuit and the radiating element, wherein
the electronic component includes
a first terminal,
a second terminal,
a first coil connected in series between the first terminal and the second terminal,
a second coil coupled to the first coil by magnetic field coupling, and
a first capacitor electrically connected in parallel to the second coil.

2. The antenna device according to claim 1, wherein a resonant frequency of a parallel circuit including the second coil and the first capacitor is a frequency between a plurality of resonant frequencies of the radiating element.

3. The antenna device according to claim 1, wherein the first coil is electrically directly connected to one end of the second coil, and is not electrically directly connected to the other end of the second coil.

4. The antenna device according to claim 1, wherein the first coil is not electrically directly connected to the second coil.

5. The antenna device according to claim 1, wherein in the electronic component, the first terminal is electrically connected to the feed circuit and the second terminal is electrically connected to the radiating element.

6. The antenna device according to claim 1, wherein in the electronic component, the first terminal is electrically connected between the feed circuit and the radiating element and the second terminal is electrically connected to a ground electrode.

7. The antenna device according to claim 1, wherein the electronic component further includes a second capacitor electrically connected in parallel to the first coil.

8. The antenna device according to claim 1, wherein an effective inductance of the electronic component in a first frequency range is greater than an effective inductance of the electronic component in a second frequency range, the second frequency range being at a higher frequency than the first frequency range.

9. The antenna device according to claim 1, wherein the electronic component is a laminated structure including a plurality of insulating layers.

10. The antenna device according to claim 9, wherein the first coil includes a first set of conductor patterns on one or more of the plurality of insulating layers, and the second coil includes a second set of conductor patterns on other ones of the plurality of insulating layers.

11. An electronic component for establishing impedance matching between a feed circuit and a radiating element in a radio-frequency circuit, the electronic component comprising:
a first terminal;
a second terminal;
a first coil connected in series between the first terminal and the second terminal;
a second coil coupled to the first coil by magnetic field coupling; and
a first capacitor electrically connected in parallel to the second coil.

12. The electronic component according to claim 11, wherein the first coil is electrically directly connected to one end of the second coil, and is not electrically directly connected to the other end of the second coil.

13. The electronic component according to claim 11, wherein the first coil is not electrically directly connected to the second coil.

14. The electronic component according to claim 11, further comprising:
a second capacitor electrically connected in parallel to the first coil.

15. The electronic component according to claim 11, wherein the electronic component is housed within a single body including a plurality of laminated insulating layers, and wherein the first coil, the second coil, and the first capacitor are integrally formed within the single body.

16. The electronic component according to claim 11, wherein an effective inductance of the electronic component in a first frequency range is greater than an effective inductance of the electronic component in a second frequency range, the second frequency range being at a higher frequency than the first frequency range.

17. A method for impedance matching a radio-frequency circuit operable in at least a first frequency range and a second frequency range, the second frequency range being higher than the first frequency range, the method comprising:
providing an electronic component including a first terminal, a second terminal, a first coil connected between the first terminal and the second terminal, a second coil magnetically coupled to the first coil, and a first capacitor connected in parallel with the second coil, wherein the second coil and the first capacitor form a resonant circuit having a resonant frequency;
selecting values for the second coil and the first capacitor such that the resonant frequency is between the first frequency range and the second frequency range; and
electrically connecting the electronic component between a feed circuit and a radiating element of the radio-frequency circuit such that an inductance of the electronic component is higher in the first frequency range than in the second frequency range.

18. The method according to claim 17, wherein electrically connecting the electronic component includes connecting the first terminal to the feed circuit and connecting the second terminal to the radiating element.

19. The method according to claim 17, wherein electrically connecting the electronic component includes connecting the first terminal to a node between the feed circuit and the radiating element and connecting the second terminal to a ground.
